(19) United States
(12) Patent Application Publication
(10) Pub. No.: US 2010/0089931 A1
(43) Pub. Date: Apr. 15, 2010

(54) Paint container accessory

(76) Inventor: Kevin Sheehy, Chicago, IL (US)

Correspondence Address: Dean A. Monoco with WOOD/PHillips, Suite 3800, 500 W. Madison, CHICAGO, IL, 60661, US

(21) Appl. No.: 12/287,812

(22) Filed: Oct. 14, 2008

(51) Int. Cl. B05C 21/00; B65D 25/20

(52) U.S. Cl. 220/701; 220/695; 15/257.06

(57) ABSTRACT

An attachment for a paint can having a lid with an annular protrusion fitting in sealing relation with a corresponding annular groove in a top surface of the can body includes an annular base having an annular protrusion adapted and constructed to fit into the annular groove of the can body. A generally planar roller strainer is connected to the base and extends angularly into the can when the base is mounted on the can. A generally planar scraper/handle element extends from the base at a location spaced apart from the roller strainer.

### CROSS-REFERENCE TO RELATED APPLICATION

None.

### BACKGROUND OF THE INVENTION

Naturally occurring pigments such as ochres and iron oxides have been used as colorants since prehistoric times. Archaeologists have uncovered evidence that early humans used paint for aesthetic purposes such as body decoration. Pigments and paint grinding equipment believed to be between 350,000 and 400,000 years old have been reported in a cave at Twin Rivers, near Lusaka, Zambia.

Persian, Chinese and Japanese sources all show extensive knowledge of pigments with exotic sounding cinnabar, azurite, malachite, lapis lazuli and indigo all being employed. The Chinese and Japanese also used the sap of a ‘Varnish Tree’ (Rhus vernicifera) which when dried, formed a lacquer. In Medieval Europe oil-based varnish slowly came into use, although mostly on paintings rather than as a protective coating, during this era oleoresinour technology developed, and by the 17th century oil based varnish was being used on ships and as caulking compounds. But it was during the period of the Industrial Revolution that paint and varnish technology began to assume the features we would recognize today.

In Colonial America, as earlier in Europe, itinerant painters roamed the countryside, carrying pigments with them, which could be mixed with a farmer's or householder's own bases, such as oil, milk, and lime. Often, the itinerant painter would be a tinker or farrier, or have some trade in addition to his knowledge of paint. Pigments would be mixed on the premises, in the colors and quantities needed, after which the painter would move on to the next town.

The metal paint can with a resealable, tightly fitting top was invented around 1868. With this development came the commercial paint industry. For the first time, paint could be manufactured in great mass, packaged in the new patented cans and shipped to stores throughout the country.

Although standard paint cans are well suited to storing and shipping paint, they are not well adapted for usage as containers for use during the painting process. The depression on the can rim in which the lid is secured acts as an unwanted reservoir for paint, and is the source of dripping and spillage. Further, the rim structure is awkward and messy when paint is poured from the can.

Accordingly, attachments for use with paint cans have been the subject of inventive effort, some examples of which can be found in the patent literature. For example, U.S. Pat. No. 6,247,600 to Sullivan is directed to a strainer device for use in straining a liquid such as paint from a container into an open receptacle. The strainer device comprises a side wall with a top end and a bottom end, an outwardly extending lip at its top end for engaging the top end of an open top container so as to support the strainer device in the open top of the container, and a screen mesh member fixed to a flange on the bottom end of said side wall. A selected portion of the side wall is indented from top to bottom so as to provide a channel along its length to permit introduction of an intake hose or other implement to a container in which the strainer device is suspended without having to first remove the strainer from the container.

U.S. Pat. No. 4,566,148 to Rollin shows a scraper device intended for scraping off and/or evening-out a liquid, e.g. paint in a container, is buoyantly disposed in the liquid. The device has a scraping surface which is grid-like and has side walls bearing against the walls of the container. The grid configuration can be formed by U-shaped strips with the opening facing downwards in the liquid. The ends of the strips are connected to each other by the side walls which suitably are doubled so that the scraper device obtains a buoyancy adapted to the viscosity of the liquid.

U.S. Pat. No. 4,299,340 to Hrytzak describes an attachment for paint cans and the like is disclosed. The attachment includes a trough shaped pouring spout which is fitted to the rim of a can by a channel section member which snaps over the rim. The spout has a curved knife edge at its outer end and slopes upwardly away from the can so that, at the end of a pouring operation, the edge will cleanly cut off the flow of paint and residual paint will flow back into the can. The curved knife edge allows the attachment to also be used for scraping paint from a roller.

U.S. Pat. No. 5,195,662 to Neff deals with a pouring spout attachment for cans of the type generally used for paints, stains, varnishes and the like that prevents paint or other liquids from running down the outside of the spout, into the lid groove, or down the outside of the can. The spout is constructed in such a way that it compensates for variations in can dimensions found in cans having the same capacity but made by different manufacturers, and also has a brush wipe bar having two functional edges; one straight smooth edge for wiping excess paint out of a brush when painting directly from a can, and a second straight serrated edge for stripping most of the paint from a brush preparatory to cleaning it after the painting job has been completed.

U.S. Pat. No. 6,213,338 to Codgill discloses a brush scraper comprising a circular cap having an inner and an outer lip, said inner and outer lips being downwardly disposed to cooperatively and frictionally engage a lid rim of a paint can and an arcuate flange which is substantially upwardly perpendicular to said circular cap and a scraper element comprising a pair of flanges extending substantially horizontally and integral with said arcuate flange and a single flange extending substantially horizontally from said pair of flanges, said scraper element extending between and being supported by said arcuate flange and a pourer which is integral with said arcuate flange, said pourer positioned on said circular cap substantially distal from said scraper element.

U.S. Pat. No. 7,137,168 to Mann is directed to a paint roller grid including a pair of hooks each including a rearwardly extending upper portion and a downwardly extending inturned lip having a forwardly facing inwardly angled surface for engaging an outer cylindrical surface of a container below the container rim when the hooks are hooked over the container rim and the grid is inserted into the top opening of the container. The hooks may be spaced from a bottom edge of the grid a distance slightly greater than the height of the container, whereby when the grid is inserted into the container opening and the hooks are hooked over the container rim, the bottom edge of the grid will engage the inside bottom surface of the container. A pair of feet may extend rearwardly from the grid for engagement with the inner cylindrical surface of the container to prevent the grid from moving within the container during rolling of a roller cover on the grid wiping surface.

U.S. Pat. No. 5,810,196 to Lundy deals with a receptacle for holding a viscous mass and for providing intermittent storage of an implement for spreading the viscous mass upon a surface, the receptacle comprising a continuous sidewall having a closed lower end and extending upwardly therefrom and terminating with a primary rim defining an opening communicating with a chamber bound by the continuous sidewall, the continuous sidewall including a primary sidewall having the primary rim and a secondary sidewall having a secondary rim located at a point subjacent the primary rim, and an auxiliary container including a bottom panel extending outwardly from the secondary panel at a point subjacent the secondary rim and an auxiliary sidewall extending outwardly from the secondary sidewall and extending upwardly from the bottom panel and terminating with an auxiliary rim located at a point proximate the primary rim, wherein the bottom panel and portions of the auxiliary sidewall and the secondary sidewall subjacent the secondary rim define a well communicating with the chamber and for holding the implement when not in use.

U.S. Pat. No. 5,727,708 to Erickson involves a form-fit, disposable liner for a reusable plastic five gallon paint bucket. The liner is a thin, structurally rigid, single piece plastic liner formed by a suitable plastic molding process. The liner includes a cylindrically shaped side wall and a semi-circularly shaped bottom wall that conform to the side wall and bottom wall of the paint bucket. An integral roller landing extends down from a semi-circular shaped top wall at an angle thereto, into a vertically extending planar side wall. The roller landing includes a series of integrally molded ridges that allow a coating product stored in the liner to be loaded into a paint roller. A domed lid is provided that engages with a rim of the liner in a snap-fit engagement to allow the paint product in the liner to be sealed.

U.S. Pat. No. 4,865,282 to Yonkman sets forth a combination paint roller wiper and paintbrush holder having a wiping surface with a plurality of hooks to hang the wiping surface in a paint bucket. The wiping surface is connected to a projection that engages the wall of the bucket when a paint roller is wiped on the wiping surface. The combination also includes a support structure for a paintbrush or the like that is attached to the wiping structure on the side opposite from the wiping surface. The support structure may be attached permanently to the wiping portion, or it may be made removable. The bottom portion of the paintbrush holder is made of a solid material with drain holes to support a standing paintbrush without damage to the bristles. The paintbrush holder also has a perforated front wall, perforated side walls and a perforated rear wall.

U.S. Pat. No. 4,083,466 to McManaway describes a paint container extension fixed to the top of a paint container for supporting a paint roller distributor or a wiping and saturating device to properly distribute paint on a roller surface. The paint container extension has a center line extending at an angle from the top of said paint container and has the plane of the top of the extension normal to the center line of the extension. The paint distributor is formed having substantially parallel sides with hooks at the top for hanging on the top of the paint container extension. The distributor is hooked over the extension where the center of the distributor is closest to the lowest point around the top of the extension. At this point, the distributor extends into the paint container at approximately the same angle as the extension. The distributor extends into the paint container to a point short of the center line of the paint container. This permits the roller to extend into the paint and make a complete revolution along the free surface of the distributor above the surface of the paint in the container when it is at least half-filled. The paint container extension has a handle and flange means at its top for receiving the paint container cover.

U.S. Design Pat. No. D456,259 to Groenwald illustrates an ornamental design for a can spout.

Although the arrangements described in these patents provide certain advantages, they present certain deficiencies as well. For example, many known devices are expensive to manufacture and unwieldy in use. It can thus be seen that the need exists for a simple, efficient, and easily manufactured paint can accessory for preventing drips, cleaning paint applicators, and/or pouring paint from the can.

### SUMMARY OF THE INVENTION

An attachment for a paint can having a lid with an annular protrusion fitting in sealing relation with a corresponding annular groove in a top surface of the can body includes an annular base having an annular protrusion adapted and constructed to fit into the annular groove of the can body. A generally planar roller strainer is connected to the base and extends angularly into the can when the base is mounted on the can. A generally planar scraper/handle element extends from the base at a location spaced apart from the roller strainer.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a perspective view of a paint can attachment in accordance with the principles of the present invention.

FIG. 2 illustrates a plan view of the FIG. 1 embodiment.

FIG. 3 illustrates a sectional view taken generally along lines III-III of FIG. 2.

FIG. 4 illustrates a sectional view of the FIG. 1 attachment mounted on a paint can.

### DETAILED DESCRIPTION OF THE INVENTION

In the following description, specific details are set forth in order to provide a thorough understanding of the invention. However, it will be apparent that the invention may be practiced without these specific details. Without departing from the generality of the invention disclosed herein and without limiting the scope of the invention, the discussion that follows, will refer to the invention as depicted in the drawings.

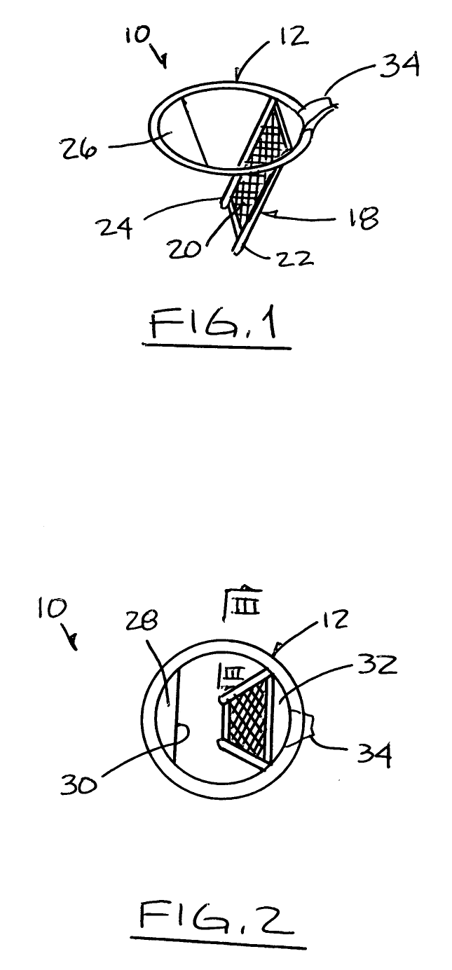

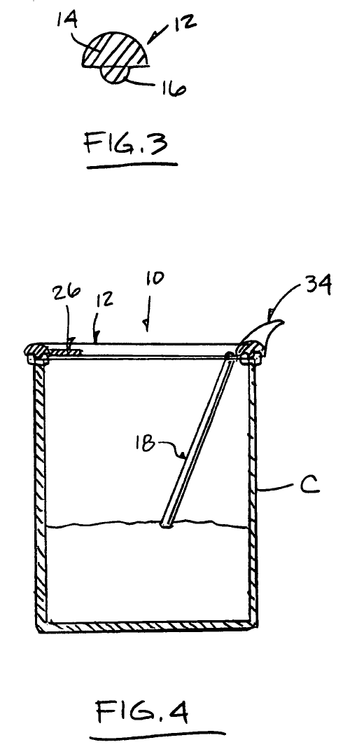

An attachment 10 for a paint can C in accordance with the principles of the present invention is shown in FIGS. 1-4. The attachment 10 includes an annular base 12 including an annular rim 14 having a semicircular cross-section. An annular protrusion 16 extends downwardly from the rim 14, and is adapted and constructed to fit into the annular groove of the can body occupied by the lid when the can is sealed. The rim 14 has a width exceeding a width of the annular protrusion 14, and is designed to minimize dripping and unwanted accumulation of paint on the rim of the can C.

A generally planar roller strainer 18 is connected to the base 12. The roller strainer 18 is composed of a mesh section 20 supported by a pair of edge supports 22, 24. The roller strainer 18 extends angularly into the can C when the base 12 is mounted on the can C, and can be hingedly or rigidly connected to the base 12 as desired.

A generally planar scraper/handle element 26 extends from the base 12 at a location spaced apart from the roller strainer 18. The scraper/handle element 26 has a semicircular body 28 terminating in a straight edge 30 facing toward the interior of the can body C. The scraper/handle element 26 is used as a handle for connecting and disconnecting the attachment 10 to the can C, as well as providing a secure element for scraping excess paint off of a paint applicator. The scraper/handle element 26 is spaced apart from the roller strainer 18, and is located opposite the roller strainer 18 in the illustrated embodiment. This placement allows each element to function without physical interference from the other.

A gap 32 is formed between the roller strainer 18 and the base 12. A pouring spout 34 extends from the base 12 adjacent to the gap 32. The pouring spout 34 facilitates relatively drip-free pouring of paint from the can C when the attachment 10 is in place.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim as my invention:

1. An attachment for a paint can having a lid with an annular protrusion fitting in sealing relation with a corresponding annular groove in a top surface of the can body, the attachment comprising the following:
an annular base including an annular protrusion adapted and constructed to fit into the annular groove of the can body;
a generally planar roller strainer connected to the base and extending angularly into the can when the base is mounted on the can; and
a generally planar scraper/handle element extending from the base at a location spaced apart from the roller strainer.

2. An attachment in accordance with claim 1, wherein the base further comprises an annular rim having a semicircular cross-section and a width exceeding a width of the annular protrusion of the base.

3. An attachment in accordance with claim 1, further comprising a gap between the roller strainer and the base.

4. An attachment in accordance with claim 3, further comprising a spout extending from the base adjacent to the gap.

5. An attachment in accordance with claim 1, wherein the scraper/handle element further comprises a semicircular body terminating in a straight edge facing toward the interior of the can body.

6. An attachment in accordance with claim 1, wherein the roller strainer further comprises a mesh section.

7. An attachment in accordance with claim 1, wherein the roller strainer is hingedly connected to the base.

8. An attachment in accordance with claim 1, wherein the scraper/handle element extends from the base at a location opposite the roller strainer.

9. An attachment in accordance with claim 1, wherein the attachment is fabricated from a plastic material.

10. An attachment in accordance with claim 1, wherein the attachment is fabricated from a thermoplastic material.
